(19) United States
(12) Patent Application Publication
(10) Pub. No.: US 2025/0341681 A1
(43) Pub. Date: Nov. 6, 2025

(54) OPTICAL COUPLING MODULE

(71) Applicant: ELECTRONICS AND TELECOMMUNICATIONS RESEARCH INSTITUTE, Daejeon (KR)

(72) Inventors: Jin Tae KIM, Daejeon (KR); Jaegyu Park, Daejeon (KR); Jung Jin Ju, Daejeon (KR)

(73) Assignee: ELECTRONICS AND TELECOMMUNICATIONS RESEARCH INSTITUTE, Daejeon (KR)

(21) Appl. No.: 18/758,484

(22) Filed: Jun. 28, 2024

(30) Foreign Application Priority Data
May 2, 2024 (KR) 10-2024-0058759

(51) Int. Cl. G02B 6/35; G02B 6/26; G02B 6/28

(52) U.S. Cl. CPC G02B 6/3596; G02B 6/262; G02B 6/2848

(57) ABSTRACT

Provided is an optical coupling module. The optical coupling module includes a light source configured to output an optical signal, an optical module configured to convert the optical signal into a light sheet, and a planar optical waveguide on a substrate, wherein the planar optical waveguide includes an input waveguide provided to one end portion of the planar optical waveguide, the light sheet includes input light that is incident between an upper surface and lower surface of an incidence surface of the input waveguide, and a thickness of the input light of the light sheet is less than a horizontal width of the input light of the light sheet.

### CROSS-REFERENCE TO RELATED APPLICATIONS

This U.S. non-provisional patent application claims priority under 35 U.S.C. § 119 of Korean Patent Application No. 10-2024-0058759, filed on May 2, 2024, the entire contents of which are hereby incorporated by reference.

### BACKGROUND

The present disclosure herein relates to an optical coupling module, and more particularly, to an optical coupling module that allows light to be incident on a planar optical waveguide circuit.

Planar optical waveguide circuits based on an X-on-insulator (XOI where x includes Si, Si₃N₄, LiNbO₃, GaAs, AlGaAs, Ta₂O₅, silicon-carbide, etc.), which have significantly advanced in recent years, are applied to photonics artificial intelligence platforms and photonics quantum technology in addition to existing optical communication component technology. Despite the development of the XOI-based planar optical waveguide technology, a technology (optical coupling) for making light incident on a planar optical waveguide still has limitations to be overcome in order to develop high-performance planar optical waveguide circuits.

### SUMMARY

The present disclosure provides an optical coupling module capable of minimizing optical loss due to optical coupling between a light source and a planar optical waveguide.

An embodiment of the inventive concept provides an optical coupling module including: a light source configured to output an optical signal; an optical module configured to convert the optical signal into a light sheet; and a planar optical waveguide on a substrate, wherein the planar optical waveguide includes an input waveguide provided to one end portion of the planar optical waveguide, the light sheet includes input light that is incident between an upper surface and lower surface of an incidence surface of the input waveguide, and a thickness of the input light of the light sheet is less than a horizontal width of the input light of the light sheet.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view of an optical coupling module according to some embodiments of the inventive concept;

FIG. 2 is a diagram schematically illustrating a profile of the light sheet of FIG. 1;

FIG. 3 is a cross-sectional view taken along line A-A′ of FIG. 1;

FIG. 4 is a perspective view of an optical coupling module according to some embodiments of the inventive concept;

FIG. 5 is a perspective view of the metasurface element of FIG. 4; and

FIG. 6 is a perspective view of an optical coupling module according

to some embodiments of the inventive concept.

### DETAILED DESCRIPTION

Embodiments of the inventive concept will now be described in detail with reference to the accompanying drawings. Advantages and features of embodiments of the inventive concept, and methods for achieving the advantages and features will be apparent from the embodiments described in detail below with reference to the accompanying drawings. However, the inventive concept may be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terminology used herein is not for delimiting the embodiments of the inventive concept but for describing the embodiments. The terms of a singular form may include plural forms unless otherwise specified. It will be further understood that the terms “includes”, “including”, “comprises”, and/or “comprising”, when used ‘in this description, specify the presence of stated elements, operations, and/or components, but do not preclude the presence or addition of one or more other elements, operations, and/or components. Furthermore, reference numerals, which are presented in the order of description, are provided according to the embodiments and are thus not necessarily limited to the order.

The embodiments of the inventive concept will be described with reference to example cross-sectional views and/or plan views. In the drawings, the dimensions of layers and regions are exaggerated for clarity of illustration. Therefore, the forms of the example drawings may be changed due to a manufacturing technology and/or error tolerance. Therefore, the embodiments of the inventive concept may involve changes of shapes depending on a manufacturing process, without being limited to the illustrated specific forms.

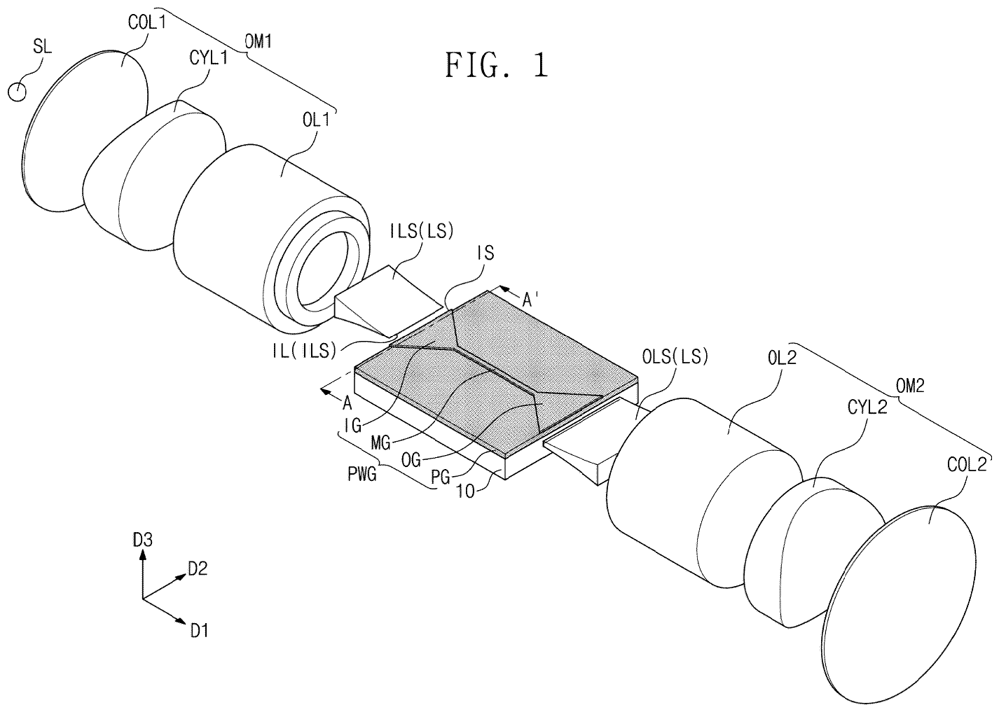

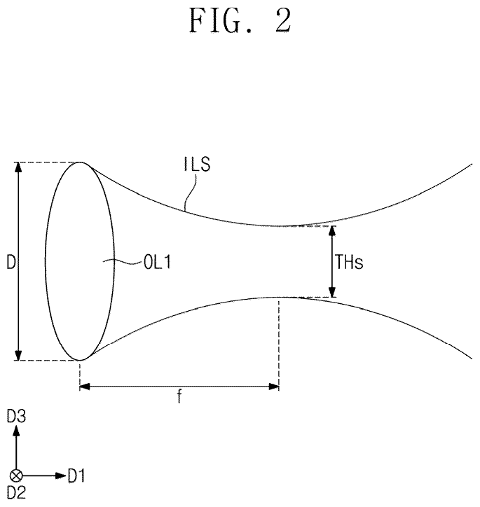

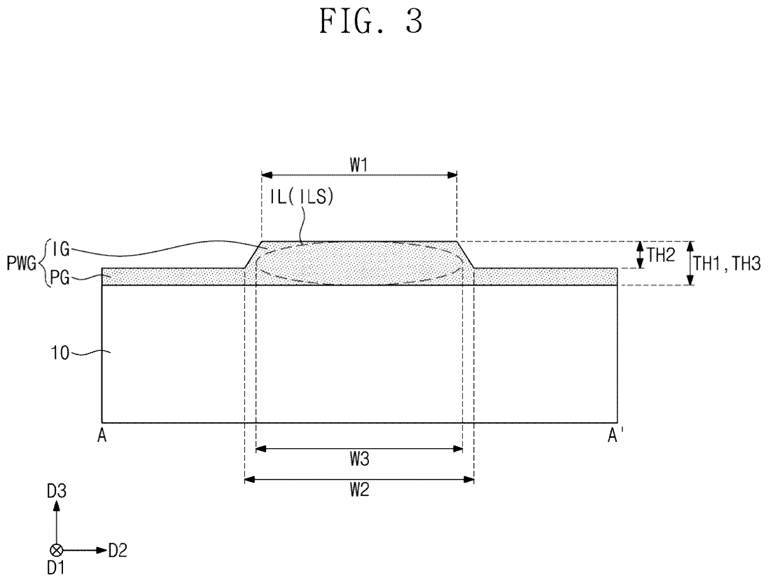

FIG. 1 a perspective view of an optical coupling module according to some embodiments of the inventive concept. FIG. 2 is a diagram schematically illustrating a profile of the light sheet of FIG. 1. FIG. 3 is a cross-sectional view taken along line A-A′ of FIG. 1.

Referring to FIG. 1, the optical coupling module according to some embodiments of the inventive concept may include a planar optical waveguide PWG on a substrate 10. The substrate 10 may have a plate shape extending along a first direction D1 and a second direction D2. The first direction D1 and the second direction D2 may be parallel to an upper surface of the substrate 10 and may intersect each other. For example, the substrate 10 may be an insulating substrate including an insulating material.

The planar optical waveguide PWG may be stacked on the upper surface of the substrate 10 in a third direction D3. The third direction D3 may be perpendicular to the upper surface of the substrate 10 and may intersect the first direction D1 and the second direction D2. The planar optical waveguide PWG may have a plate shape extending in the first direction D1 and the second direction D2. For example, the planar optical waveguide PWG may include at least one of Si, Si₃N₄, LiNbO₃, GaAs, AlGaAs, Ta₂O₅, or silicon-carbide.

The planar optical waveguide PWG may include a planar waveguide PG on the substrate 10, an input waveguide IG provided to one end portion of the planar waveguide PG, an output waveguide IG provided to another end portion of the planar waveguide PG, and an intermediate waveguide MG between the output waveguide OG and the input waveguide IG. The input waveguide IG may be provided to the one end portion of the planar optical waveguide PWG on which a light sheet LS that will be described later is incident. The output waveguide OG may be provided to the other end portion of the planar optical waveguide PWG through which the light sheet LS is output.

The input waveguide IG may have a tapered shape so that a width of the input waveguide IG in the second direction D2 decreases in the first direction D1. The output waveguide OG may have a tapered shape so that a width of the output waveguide OG in the second direction D2 decreases in an opposite direction of the first direction D1. For example, a width of the intermediate waveguide MG in the second direction D2 may be substantially the same. The input waveguide IG may be connected to the output waveguide OG through the intermediate waveguide MG. For example, the input waveguide IG, the intermediate MG, and the output waveguide OG may form a single seamless integrated shape.

A light source SL that outputs an optical signal may be provided on one side surface of the planar optical waveguide PWG. The light source SL may output an optical signal toward the input waveguide IG of the planar optical waveguide PWG. For example, the light source SL may include an optical fiber. For example, the optical fiber may be a single-mode optical fiber. For example, a wavelength of the optical signal output from the light source SL may be about 780 nm or about 1550 nm.

A first optical module OM1 may be provided between the light source SL and the planar optical waveguide PWG. The first optical module OM1 may convert the optical signal output from the light source SL into the light sheet LS. The light sheet LS may be very thin two-dimensional laser light capable of illuminating a thin slice of a sample and exciting fluorescence.

The first optical module OM1 may include a first collimator lens COL1, a first cylindrical lens CYL1, and a first objective lens OL1 that are sequentially provided between the light source SL and the planar optical waveguide PWG, but is not limited thereto. The first optical module OM1 may be a single optical lens or a combination of multiple optical lenses for converting the optical signal output from the light source SL into the light sheet LS.

The optical signal output from the light source SL may be incident on the first collimator lens COL1. The first collimator lens COL1 may perform a function of making incident light rays parallel to each other. For example, the optical signal output from the light source SL may diverge. Since the diverging optical signal is incident on the first collimator lens COL1, the diverging optical signal may propagate in parallel. Although the single first collimator lens COL1 is illustrated in the drawings, the number of the first collimator lenses COL1 is not limited thereto. A combination of multiple collimator lenses or multiple optical lenses may be provided to make the diverging optical signal parallel.

The optical signal propagated in parallel by the first collimator lens COL1 may be incident on the first cylindrical lens CYL1. The first cylindrical lens CYL1 may fix incident light rays to one axis, and may focus or defocus the light rays to another axis. For example, although not illustrated in the drawings, the first cylindrical lens CYL1 may focus the incident optical signal to an x axis (e.g., a direction parallel to the upper surface of the substrate 10) up to a focal point, and, after the focal point, the optical signal may be defocused in a direction of the x axis. For example, at the same time, the first cylindrical lens CYL1 may fix the incident optical signal to a y axis (e.g., a direction perpendicular to the upper surface of the substrate 10). That is, the first cylindrical lens CYL1 may convert the optical signal into a preliminary light sheet defocused in the x axis direction and fixed in the y axis direction.

The preliminary light sheet formed by the first cylindrical lens CYL1 may be incident on the first objective lens OL1. The first objective lens OL1 may perform a function of decreasing a thickness of an incident light ray. In the present disclosure, a thickness is defined as a width in the third direction D3. The preliminary light sheet formed by the first cylindrical lens CYL1 may be incident on the first objective lens OL1 and thus may be converted into the light sheet LS. In particular, the light sheet LS, which is incident on the planar optical waveguide PWG, is defined as an incident light sheet ILS.

The incident light sheet ILS may be incident from the first objective lens OL1 onto the input waveguide IG of the planar optical waveguide PWG along the first direction D1. The incident light sheet ILS may decrease in thickness in the first direction D1 between the first objective lens OL1 and the input waveguide IG of the planar optical waveguide PWG.

FIG. 2 is a diagram schematically illustrating a profile of the incident light sheet ILS propagating from the first objective lens OL1 in the first direction D1. In the drawings, D denotes a diameter of the first object lens OL1. For example, when the first objective lens OL1 includes a single lens, D may be the diameter D of the single lens. For another example, when the first objective lens OL1 includes a plurality of lens, D may be the diameter D of a last lens in the first object lens OL1 in a propagating direction of the preliminary light sheet. In the drawings, f denotes a focal length of the first object lens OL1. For example, when the first objective lens OL1 includes a single lens, f may be the focal length f of the single lens. For another example, when the first objective lens OL1 includes a plurality of lens, f may be the focal length f of a last lens in the first object lens OL1 in a propagating direction of the preliminary light sheet.

In a propagating direction of the incident light sheet ILS, a thickness of the incident light sheet ILS may decrease between the first objective lens OL1 and a point at the focal length f from the first objective lens OL1, and may decrease after the point at the focal length from the first object lens OL1. Accordingly, the incident light sheet ILS may have a minimum thickness THs at the point at the focal length f from the first objective lens OL1.

$$THs = \frac{2 λ f}{π D} = \frac{n λ}{π NA}$$

Here, λ denotes a wavelength of an optical signal of the light source SL, n denotes a refractive index of a medium, and NA denotes a numerical aperture of the first objective lens OL1. The minimum thickness THs of the incident light sheet ILS may be adjusted by adjusting the above variables.

Referring to FIGS. 1 to 3, the incident light sheet ILS may be incident on an incidence surface IS of the input waveguide IG. Portion of the incident light sheet ILS which meets the incidence surface IS of the input waveguide IG is defined as input light IL.

The input waveguide IG may have a first thickness TH1 between an upper surface and lower surface of the input waveguide IG. The input waveguide IG may include a region protruding from the planar waveguide PG in the third direction D3, wherein the protruding region may have a second thickness TH2. The input waveguide IG may have a first width W1 in the second direction D2 at an upper surface of the input waveguide IG and a second width W2 in the second direction D2 at a lower surface of the input waveguide IG. For example, the first thickness TH1 may be about 600 nm to about 700 nm. The second thickness TH2 may be greater than 0 nm and equal to or less than about 300 nm, but is not limited thereto. For example, although not illustrated in the drawings, the second thickness TH2 may be 0 nm, that is, the protruding region of the input waveguide IG may not be formed. For example, the first width W1 may be about 1 mm to about 10 mm. The second width W2 may be substantially the same as or greater than the first width W1. For example, when the second width W2 is greater than the first width W1, a difference between the second width W2 and the first width W1, i.e., W2-W1, may be 2*TH1/tan (70° or less. Here, TH1 denotes the thickness TH1 of the incidence surface IS of the input waveguide IG. The first thickness TH1, the second thickness TH2, the first width W1, and the second width W2 are not limited to the above values, and may be differently designed according to a refractive index of a material of the planar optical waveguide PWG.

The input light IL of the incident light sheet ILS may have a third thickness TH3 and a horizontal width W3 along the third second D2. The input light IL of the incident light sheet ILS may correspond to the incident light sheet ILS having the minimum thickness THs at the point at the focal length f from the first objective lens OL1 described with reference to FIG. 2. Accordingly, the third thickness TH3 of the input light IL of the incident light sheet ILS may be adjusted by adjusting the minimum thickness THs.

According to the inventive concept, the incident light sheet ILS formed through the first optical module OM1 may be incident on the input waveguide IG of the planar optical waveguide PWG. The thickness THs (FIG. 2) of the incident light sheet ILS may be adjusted to approximate the first thickness TH1 of the incidence surface IS of the input waveguide IG through the first optical module OM1. In addition, the horizontal width W3 of the incident light sheet ILS may be adjusted, through the first optical module OM1, to approximate a width of a guide mode (e.g., the second width W2 of the incidence surface IS of the input waveguide IG) formed by the planar optical waveguide PWG. Accordingly, optical loss due to optical coupling between the input light IL of the light sheet ILS and the incidence surface IS of the input waveguide IG may be minimized. Therefore, the performance of the optical coupling module may be improved.

The light sheet LS may pass through the input waveguide IG and the intermediate waveguide MG and propagate to the output waveguide OG. The light sheet LS may be output from the output waveguide OG. The output light sheet LS is defined as output light sheet OLS. For example, the output light sheet OLS may propagate with a greater horizontal width than the horizontal width of the output waveguide OG. For example, the output light sheet OLS may propagate with a greater thickness than the thickness of the output waveguide OG.

The output light sheet OLS may be converted into a converging optical signal through a second optical module OM2. The second optical module OM2 may include a second objective lens OL2, a second cylindrical lens CYL2, and a second collimator lens COL2 that are sequentially provided from the planar optical waveguide PWG, but is not limited thereto. The second optical module OM2 may be a single optical lens or a combination of multiple optical lenses for converting the output light sheet OLS into the converging optical signal.

Although not illustrated in the drawings, the optical signal converted from the output light sheet OLS may propagate to a separate light source (e.g., optical fiber).

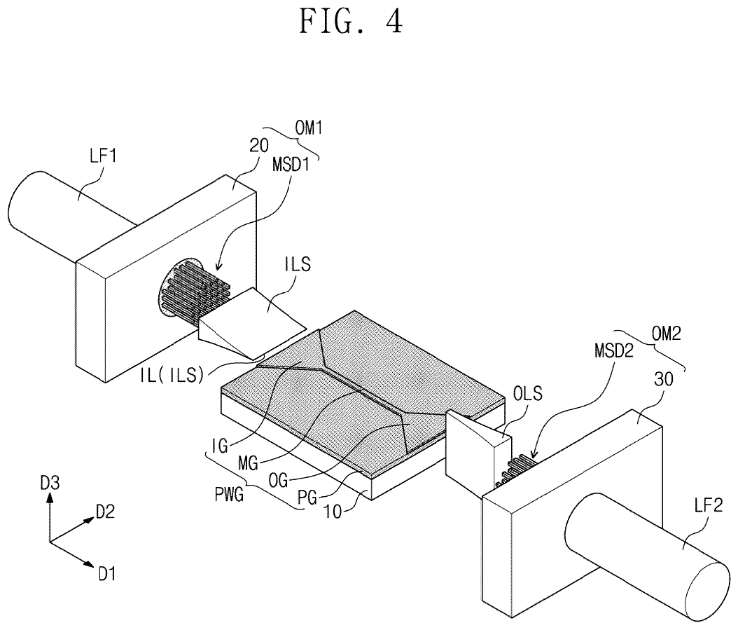

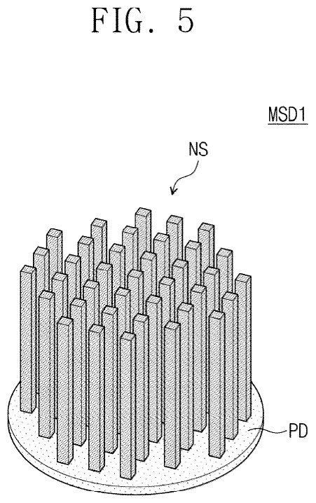

FIG. 4 is a perspective view of an optical coupling module according to some embodiments of the inventive concept. FIG. 5 is a perspective view of a portion of the metasurface element of FIG. 4. For conciseness, descriptions overlapping with the above descriptions will not be provided.

Referring to FIGS. 4 and 5, the optical coupling module according to some embodiments of the inventive concept may include a first optical fiber LF1 as a light source. Features of an optical signal output from the first optical fiber LF1 may be the same as or similar to features of the optical signal of the light source SL described with reference to FIG. 1. In addition, the substrate 10 described with reference to FIGS. 1 to 3 is defined as a first substrate 10.

The first optical module OM1 may be provided between the first optical fiber FL1 and the planar optical waveguide PWG. The first optical module OM1 may include a second substrate 20 between the first optical fiber LF1 and the planar optical waveguide PWG and a first metasurface element MSD1 between the second substrate 20 and the planar optical waveguide PWG. The first metasurface element MSD1 is an optical element in which a nano-structure array with a subwavelength shorter than a wavelength of the optical signal output from the first optical fiber LF1 is regularly arranged according to design, and is an ultra-thin planar optical element that modulates an amplitude, phase, and polarization of an optical signal incident on the first metasurface element MSD1. The first metasurface element MSD1 is a nano-optical element capable of generating the incident light sheet ILS described with reference to FIGS. 1 to 3, and a spatial phase profile of light may be designed on the basis of the equation below.

$$φ ( r ) = \frac{2 π}{λ} \frac{{R}^{2}}{2 {δ}_{zq}} ln ( {f}_{0} + \frac{{δ}_{zq}}{{R}^{2}} {r}^{2} )$$

Here, f₀ denotes a paraxial focal length, δ_{zq} denotes a focal depth, R denotes a normalized radius, and λ denotes a wavelength of an optical signal.

The optical signal output through the first optical fiber LF1 may be converted into the light sheet LS through the first metasurface element MSD1.

The second substrate 20 may be an insulating substrate including an insulating material. For example, the second substrate 20 may include SiO₂. The first metasurface element MSD1 may include a pad part PD and a plurality of nano-structures NS extending from the pad part PD in the first direction D1. The nano-structures NS are illustrated as having a cuboid shape, but are not limited thereto. For example, the nano-structures NS may include at least one of GaN, a-Si, TiO₂, or Si₃N₄, but are not limited thereto.

The incident light sheet ILS may be formed by those skilled in the art by making various corrections and modifications to arrangement, interval, number, shape, and the like of the nano-structures NS of the first metasurface element MSD1.

According to the inventive concept, the thickness THs (FIG. 2) of the incident light sheet ILS converted through the first metasurface element MSD1 may be adjusted to approximate the first thickness TH1 of the incidence surface IS of the input waveguide IG. In addition, the horizontal width W3 of the incident light sheet ILS converted through the first metasurface element MSD1 may be adjusted to approximate a width of a guide mode (e.g., the second width W2 of the incidence surface IS of the input waveguide IG) formed by the planar optical waveguide PWG. Accordingly, optical loss due to optical coupling between the input light IL of the light sheet ILS and the incidence surface IS of the input waveguide IG may be minimized. Therefore, the performance of the optical coupling module may be improved.

The output light sheet OLS may be converted into a converging optical signal through a second optical module OM2. The second optical module OM2 may include a second metasurface element MSD2 and a third substrate 30 that are sequentially provided from the planar optical waveguide PWG. Features of the second metasurface element MSD2 may be the same as or similar to features of the first metasurface element MSD1. The second metasurface element MSD2 may be provided in a 90° rotated state compared to the first metasurface element MSD1. The output light sheet OLS may be provided in a 90° rotated state compared to the incident light sheet ILS. Features of the third substrate 30 may be the same as or similar to features of the second substrate 20.

The optical signal converted from the output light sheet OLS may propagate to a second optical fiber LF2. Features of the second optical fiber LF2 may be the same as or similar to features of the first first optical fiber LF1.

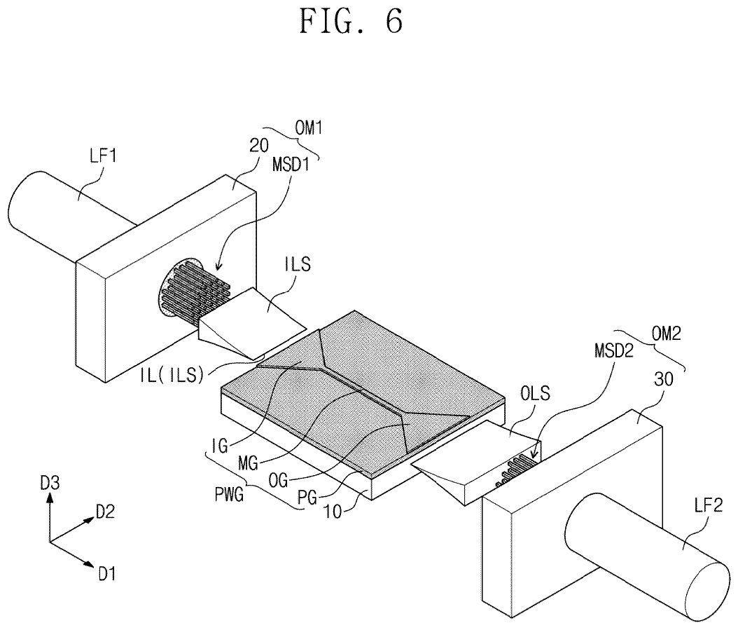

FIG. 6 is a perspective view of an optical coupling module according to some embodiments of the inventive concept.

Referring to FIG. 6, the second metasurface element MSD2 may not be 90° rotated compared to the first metasurface element MSD1, unlike the above descriptions provided with reference to FIG. 4. Accordingly, the output light sheet OLS may be similar to a profile of the incident light sheet ILS according to an opposite direction of the propagating direction of the incident light sheet ILS.

According to the inventive concept, optical loss due to optical coupling may be minimized by allowing a light sheet to be incident on a planar optical waveguide. As a result, optical efficiency of an optical coupling module may be improved.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An optical coupling module comprising:
a light source configured to output an optical signal;
an optical module configured to convert the optical signal into a light sheet; and
a planar optical waveguide on a substrate,
wherein the planar optical waveguide includes an input waveguide provided to one end portion of the planar optical waveguide,
the light sheet includes input light that is incident between an upper surface and lower surface of an incidence surface of the input waveguide, and
a thickness of the input light of the light sheet is less than a horizontal width of the input light of the light sheet.

2. The optical coupling module of claim 1, wherein the thickness of the input light of the light sheet is substantially the same as or less than a thickness of the incidence surface of the input waveguide.

3. The optical coupling module of claim 1, wherein the horizontal width of the input light of the light sheet is substantially the same as or less than a width of the lower surface of the incidence surface of the input waveguide.

4. The optical coupling module of claim 1, wherein a width of the upper surface of the incidence surface of the input waveguide is 1 mm to 10 mm.

5. The optical coupling module of claim 1,
wherein the planar optical waveguide further includes a planar waveguide on the substrate,
the incidence surface of the input waveguide includes a protruding region protruding from the planar waveguide, and
a thickness of the protruding region of the incidence surface is greater than 0 nm and equal to or less than 300 nm.

6. The optical coupling module of claim 1, wherein the light sheet decreases in thickness between the optical module and the input waveguide.

7. The optical coupling module of claim 1, wherein a width of the input waveguide in a second direction intersecting a first direction decreases in the first direction parallel to an upper surface of the substrate.

8. The optical coupling module of claim 1, wherein the optical module further includes:
a cylindrical lens configured to convert the optical signal into the light sheet; and
an objective lens configured to make the light sheet thin.

9. The optical coupling module of claim 1,
wherein the substrate is a first substrate,
the optical module includes a second substrate and a metasurface element on the second substrate, and
the metasurface elements includes a pad on the second substrate and a plurality of nano-structures extending in a first direction parallel to an upper surface of the first substrate.

10. The optical coupling module of claim 9,
wherein the planar optical waveguide further includes an output waveguide provided to another end portion of the planar optical waveguide, and
output light sheet that is output from the output waveguide is further included,
wherein the output light sheet has a 90° rotated profile compared to the incident light sheet.

11. The optical coupling module of claim 9,
wherein the planar optical waveguide further includes an output waveguide provided to another end portion of the planar optical waveguide, and
output light sheet that is output from the output waveguide is further included,
wherein the output light sheet has a profile that is mirror symmetrical to the incident light sheet.
